(19) United States
(12) Patent Application Publication
(10) Pub. No.: US 2009/0191920 A1
(43) Pub. Date: Jul. 30, 2009

(54) Multi-Function Electronic Ear Piece

(76) Inventors: Paul Regen, Felton, CA (US); Peter Garrett, Aptos, CA (US)

Correspondence Address: CENTRAL COAST PATENT AGENCY, INC, 3 HANGAR WAY SUITE D, WATSONVILLE, CA, 95076, US

(21) Appl. No.: 12/361,760

(22) Filed: Jan. 29, 2009

Related U.S. Application Data
(60) Provisional application No. 61/024,302, filed on Jan. 29, 2008.

(51) Int. Cl. H04B 1/38; H04M 1/00; G06F 17/00

(52) U.S. Cl. 455/566; 455/569.1; 700/94

(57) ABSTRACT

An electronic device includes a transceiver, a solid state memory, a charge port, at least one speaker, and a software music player. The device is adapted by toggle interface to function as a telephone hands free earpiece, a wireless flash drive, or a wireless music player.

### CROSS-REFERENCE TO RELATED APPLICATIONS

The present invention claims priority to a U.S. provisional patent application Ser. No. 61/024,302, filed Jan. 29, 2008, and entitled “ION Technologies Wireless Mobile Phone Headset with Internal Wireless Flash Drive & MP3 Player”.

### BACKGROUND OF THE INVENTION

1. Field of the Invention

The present invention is in the field of electronic devices, and pertains particularly to an electronic device adapted for wireless communications, data storage, and music consumption.

2. Discussion of the State of the Art

In the field of electronics there are devices known as mobile or portable hands-free headsets. Such devices work over a wireless frequency to receive audio from a mobile telephone or other source device and to transmit audio from the headset back to the source device. A typical and well-known device of this type is known as a Bluetooth headset. Such devices may include such as an ear clip, a charging port, a volume control, a touch button for accepting a call, and an on and off switch.

Another well-known electronics device is a flash drive, often called a thumb drive by consumers. A Flash drive is a solid-state memory device that typically docks to a host device like a personal computer (PC) through a universal serial bus (USB) port. A Flash drive is recognized as an external drive by most computer operating systems, and while connected to the host, files may be transferred between the host and the drive similar to the way the computer works with the internal storage system.

Yet another type of electronic device is used primarily for entertainment purposes and is known as a digital music player, or MP3 player. There are several different brands of digital music players commercially available. A software or firmware platform enables the device to read and play digital music files. Such a device typically includes a display screen for displaying song titles and relevant information, and buttons for controlling play. Like a flash drive, memory is available on an MP3 player for storing audio files to play. Some players are enabled for display of video and photos as well as playing music. An ear bud speaker system, or other type headset is typically available with the MP3 device for listening to music played on the device, and many are enabled for wireless transmission to wireless headsets.

It has occurred to the inventor that although the mentioned devices are distinctly separate devices used for different purposes, there are similarities that each device has with respect to at least one other of the devices. For example a flash drive and an MP3 player both have solid-state storage capacity and both may be coupled to a PC for file synchronization. A mobile headset and an MP3 player both are used to transmit audio to a user. It has further occurred to the inventor that an electronic device is needed in the art that provides all of the functions of these several types of devices. Therefore, what is clearly needed is a multi-function electronics device adapted as a headset, MP3 player and Flash drive.

### SUMMARY OF THE INVENTION

A problem in the art is that there are headsets and earpieces available for wireless hands free telephone operation. There are also numerous types of small electronic music players and devices adapted for file storage and retrieval such as miniature MP3 players and Flash-based jump drives. However, all of these devices are single task devices. Users must carry multiple personalized devices to enjoy all of the services they provide.

The inventor searched for elements common to personalized electronics devices looking for elements that could be adapted for use in the performance of more than one personal task without creating complexity.

The inventor realized in an inventive moment that if certain device features on a personal electronics device could be harnessed to provide multiple and varied services to a user operating the device then significant improvement in task performance and resource conservation might result.

The inventor therefore constructed a unique electronics device that allowed users to perform multiple tasks from the same device by incorporating multiple functions onto a single interface. A significant saving in time and labor results, with no undue complexity created.

Accordingly, in one embodiment of the invention, an electronic device includes a transceiver, a solid state memory, a charge port. at least one speaker, and a software music player. The earpiece is characterized in that the device is adapted by toggle interface to function as a telephone hands free earpiece, a wireless flash drive, or a wireless music player.

In one embodiment the device is enabled for Bluetooth communication playing music and as a mass storage device. In a variation of this embodiment the solid state memory is a flash memory recognized as a memory drive by a host system. In one embodiment the flash drive is accessible from a host system via wireless USB link. In a variation of this embodiment the earpiece further includes a retractable USB connector for coupling to a USB port on a host system.

In a preferred embodiment the speaker is contained in an ear bud integral to the earpiece. Also in a preferred embodiment, the ear bud is concealable on the device. In one embodiment the earpiece further includes a retractable ear clip that is integral to and concealable on the device. In one embodiment the device further includes an audio port for accepting a wired speaker or speaker set.

In one embodiment using USB, the retractable USB connector functions as a charging point. In one embodiment the earpiece further includes a visual display screen. In a variation of this embodiment the display screen is a touch activated screen and is an organic light emitting diode (OLED), or a light emitting diode (LED).

In a preferred embodiment the contents of the display screen are relevant to the mode selected and include command icons for performing tasks. In one embodiment music played on the device is transmitted wirelessly to an external speaker system enabled for wireless reception and analog play. In one embodiment the device further includes a miniature stylus for operating the touch screen.

In one embodiment the toggle interface is activated to switch modes on arrival of a notification event. In a variation of this embodiment the notification event is a telephone call.

### BRIEF DESCRIPTION OF THE DRAWING FIGURES

FIG. 1 is a perspective view of a multi-functional electronic device according to an embodiment of the present invention.

FIG. 2 is a block diagram illustrating wireless communication capabilities of the device of FIG. 1.

FIG. 3 is an end view of the device of FIG. 1.

FIG. 4 is an elevation view of the device of FIG. 1 illustrating a concealable ear bud according to an embodiment of the invention.

FIG. 5 is an elevation view of the device of FIG. 1 with the ear bud deployed according to an embodiment of the present invention.

FIG. 6 is a process flow chart illustrating steps for operating the device in telephony mode according to an embodiment of the present invention.

FIG. 7 is a process flow chart illustrating steps for setting the device from telephony mode to flash mode according to an embodiment of the present invention.

### DETAILED DESCRIPTION

The inventors provide an electronic device for transmitting and receiving digital media, the device operable according to multiple modes and settings, for use in different environments including telephony, media storage and retrieval, and music consumption.

The present invention is detailed in several embodiments described relative to the drawings.

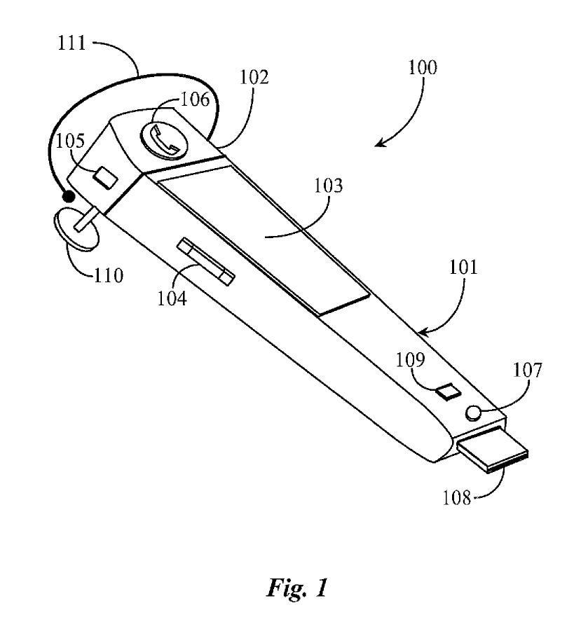

FIG. 1 is a perspective view of a multi-function electronic device 100 according to an embodiment of the present invention. Device 100 is adapted to be worn about the ear by a user, similar to a hands free Bluetooth device used with a cellular telephone. Device 100 is an electronic device housed in a lightweight polymer housing 101 enclosing the device electronics and hardware. Housing 101 may be molded or provided in pieces that are assembled together to form the protective housing.

Device 100 has all of the required electronic components necessary to enable the device to be operated as a hands free (wireless) cellular telephone earpiece. Although not illustrated here, a rechargeable power source (rechargeable batteries), a microphone, a speaker component, a microprocessor, and a wireless transceiver component may be assumed housed within housing 101 of device 100. Device 100 also includes all of the required components enabling the device to be used as a compact flash drive similar to a universal serial bus (USB) thumb drive. Although not illustrated here, device 100 may contain a solid state flash memory adapted to store media files. Software programs for manipulating files stored on the device may also be assumed present on the device.

Device 100 includes a power switch 105 for booting earpiece 100 up or shutting the earpiece off. A mode toggle switch 104 is provided on the device for toggling between multiple operating modes of the device. In one embodiment there are 3 operating modes. Telephone mode enables device 100 to be used as a hands-free cellular earpiece. Flash mode enables the device to be operated as a compact Flash drive. Music mode enables the device to be operated as an MP3 player. Device 100 may be adapted for Bluetooth, Ultra Wide Band (UWB), or another transceiver wireless technology.

Device 100 has a display screen 103 provided thereon and adapted to display appropriate operation settings and available tasks relative to a mode of operation set on the device. Display screen 103 may be a light emitting diode (LED) screen or an organic LED screen adapted as a touch screen for inputting commands to the device. In one embodiment device 100 has a mini operating system installed thereon and adapted to enable full operation of the device through available switches and through the touch screen manipulation.

Depending on the mode set with toggle switch 104, icons and information relative to that mode may be displayed on screen 103. For example, in telephone mode display screen 103 may display recently answered and unanswered calls, a contact list, dialed calls and other information. The display screen may include a touch screen scroll system to enable scrolling through telephone information such as a call list. In flash mode screen 103 may display specific actions available for touch screen initiation for manipulating files stored on the Flash memory inside the device. Options may include printing files, opening and viewing files, organizing files, and receiving and transmitting files. In one embodiment device 100 includes a miniature stylus that may be used to operate touch screen 103.

In one embodiment of the present invention, mode may be automatically switched based on an incoming event. For example, if the device is set on music mode and the user is actively listening to an MP3, an incoming telephone call registered on the user's cellular telephone may automatically cause the music mode to pause and the telephone mode to activate, allowing the user to accept the call, interrupting the playback of the music selection.

In music mode display screen 103 may display a playlist, a favorites list, a song list, and so on. A touch screen icon may be provided for invoking play. When a song is in play, traditional media player controls may be displayed for touch screen manipulation. Play, pause, stop, volume, loop, and other controls may be accessible by manipulating the touch screen.

Device 100 includes an ear bud 110 that is built into the device and is concealable from view for storage when not in use. In one embodiment ear bud 110 may be folded down and concealed within a compartment provided on the device and adapted for the purpose. In one embodiment ear bud 110 has a spring-tensioned stem that can be manually folded over but springs out automatically when the ear bud compartment is exposed. A slidable-cap cover piece 102 is provided on device 100 and is adapted to cover and conceal the ear bud when not in use.

Device 100 has an ear clip 111 in one embodiment that is integral to the device. Ear clip 111 may be manufactured of a flexible but resilient wire shaped for holding earpiece 100 into a suitable position for operation. In one embodiment ear bud 110 may be used instead of clip 111 to position the device on a user's ear. In another embodiment clip 111 is used instead of an ear bud. In another embodiment both the clip and the ear bud might be used together for extra security.

Device 100 is adapted in this example with a USB connector 108 for docking the device into a USB port on a host system for use as a non-wireless Flash drive. In another embodiment wireless USB protocol is used and the device is not required to be physically docked to or cabled to a host system. In this embodiment USB connector 108 is retractable back into earpiece 100 when it is not required for host coupling. A retraction operator 109 is provided to enable manual extension and retraction of the USB connector.

An LED indicator light 107 is provided on device 100 and is adapted to indicate successful file transferring. It is not required to have LED 107 as the state information relative to transmitting and receiving files can be displayed for a user on display screen 103.

In use, an operator may toggle between modes with the power on by manipulating one switch (104). In telephone mode, the device may be used as a traditional headset device to answer and make calls in a hands free manner. The user may switch modes on the device used as a headset without removing the headset using the toggle. For example, the user may wish to operate in Flash mode or in MP3 mode where the device may be operated as a music player.

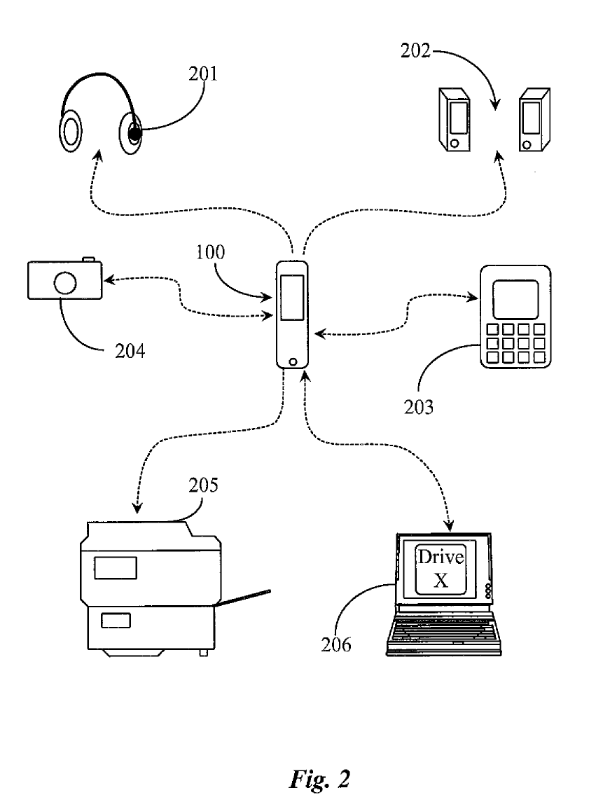

FIG. 2 is a block diagram illustrating wireless communication capabilities of device 100 of FIG. 1. Device 100 is illustrated relative to a group of communications devices enabled for wireless transmission. Device 100 can, in music mode, wirelessly transmit audio from a music selection played on the device to a headset 201 or to a pair of external wireless speakers 202. Device 100 can be used to upload pictures to and download pictures from a digital still or video camera illustrated here as a camera 204. Device 100 may be used to upload information to and download information from a digital smart phone 203. In one embodiment text files may be reviewed on the device and printed from the device.

In one embodiment files stored on the device may be opened and printed wirelessly using a printer 205 enabled for wireless communication. Device 100 may also be used as a wireless Flash drive with a wirelessly-enabled host, such as a Laptop computer illustrated herein as laptop 206. In an embodiment where there is a computing host and device 100 is set to Flash mode, the user operates the host system to put files on and to take files off of the device. In this example hosts may be smart phone 203 and laptop 206. Camera 204 may be configured as a host to device 100 or as a peripheral component to the device. With simple modification by software, device 100 may be adapted to play music over an FM channel on a car stereo or house stereo system.

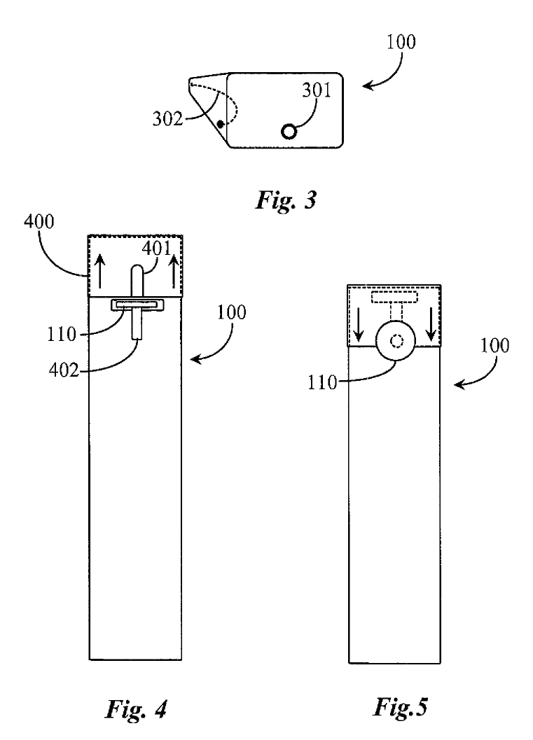

FIG. 3 is an end view of the device of FIG. 1. Earpiece 100 has an audio output port 301 provided for connecting wired headsets or wired external speakers when the unit is set to music mode and wireless connection is not desired at the time. An ear clip retaining sheath or channel 302 is provided within the device body for enabling the ear clip (111) of FIG. 1 to be concealed within the body of the device. In one embodiment, a small bead on the end of the clip enables a user to pull the clip out of the sheath for use. A small depression may be formed at the sheath opening to seat the bead at the end of the clip. A bead, hook, or other formation may be provided at the opposite end of clip 111 so that it may not be pulled completely out of the device. The sheath or channel may be straight or slightly curved and can be formed by molding or machining.

FIG. 4 is an elevation view of device 100 of FIG. 1 illustrating a concealable ear bud according to an embodiment of the invention. Ear bud 110 is concealable within the body of device 100. In this embodiment ear bud 110 is centered on the end of a tension mounted stem 402 that when concealed rests in a groove provided in the body of device 100. The stem may be spring-loaded or tensioned such that it may be collapsed within the body of the device and retained therein by a slidable cover cap 400.

In this embodiment a user may pull up on cover cap 400 to expose ear bud 110. The cover retains the assembly in concealment and when it is pulled up in the direction of the arrows to a position where the ear bud is exposed, the ear bud assembly pops out and is ready for use. After the ear bud pops out, the cover may be slid back down to its original position. A slot 401 is provided through the cover in this example to enable the cover to be pushed back down around the exposed ear bud stem 402. In one embodiment, an adjustable ball and socket joint is provided at the base of stem 401 to enable a user to fine tune the position of the ear bud for comfort.

FIG. 5 is an elevation view of earpiece 100 of FIG. 1 with the ear bud deployed according to an embodiment of the present invention. In this example, cover cap 400 is pushed down according to the directional arrows with ear bud 110 completely deployed. The ear bud cavity and stem groove are concealed beneath the cap. Pulling up on the cap cover exposes the cavity and groove so that the ear bud and stem can be manually manipulated into the cavity and groove, and then concealed by pushing back down on the cap cover. In one embodiment the ear bud stem is freely hinged and will deploy by gravity when exposed by pulling up on the cap cover. In this embodiment a tightening mechanism may be provided to secure the desired position of the ear bud for use.

In one embodiment such a mechanism may include a male/female threaded interface that encompasses the ball on the end of stem 401 (FIG. 4). The stem then can be turned clockwise to tighten it against the ball while turning it counter clockwise loosens the stem and allows it to be folded down into the provided groove. A retaining clip or other form of retainer may be provided to prevent a user from completely unthreading the stem and ear bud. The speaker wire leading from the ear bud into the unit can be routed so that it does not interfere with the adjustment of the stem.

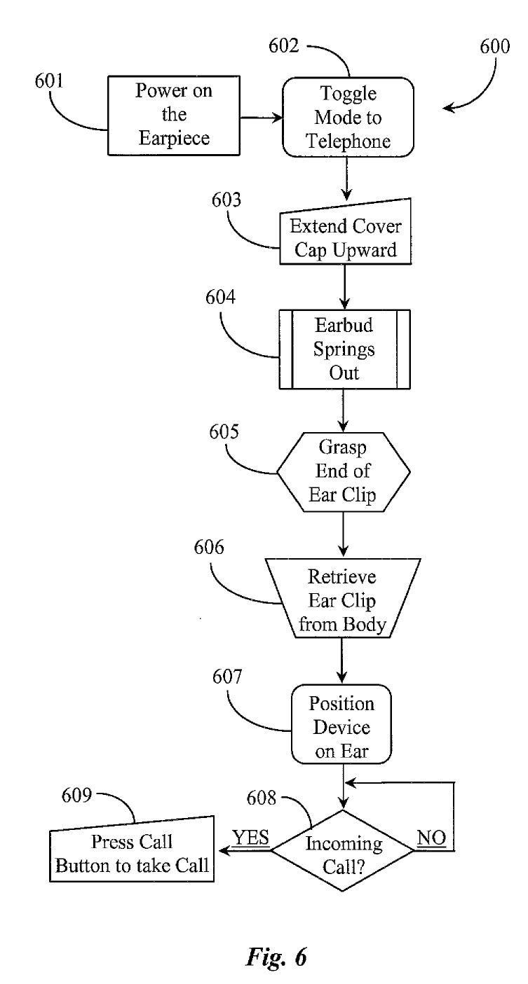

FIG. 6 is a process flow chart illustrating steps 600 for operating the device in telephony mode according to an embodiment of the present invention. At step 601 a user powers on the device by turning the power switch to the on position. At step 602 the user may move the toggle switch to the telephone mode position. It is assumed that the user's cellular phone is on and enabled for Bluetooth where the phone and device have already been paired.

If the ear bud is to be used, at step 603 the user pulls up or extends the cap cover concealing the ear bud assembly upward exposing the assembly. At step 604 the ear bud springs out under tension and is ready to use. In one embodiment the ear bud falls out by gravity and the stem must be tightened against a ball to secure a suitable position.

If the ear clip is to be used at step 605 the user grasps the end (bead) of the ear clip concealed within the device body. At step 606 the ear clip is retrieved from within the device body and is ready for use. At step 607 the user positions the earpiece on the ear with the ear bud inside the ear and the clip around the ear. The earpiece listens for any incoming calls. At step 608 if the unit detects an incoming call from the telephony device at step 609 the user will hear a ringtone and may press the call button on the device to accept the call.

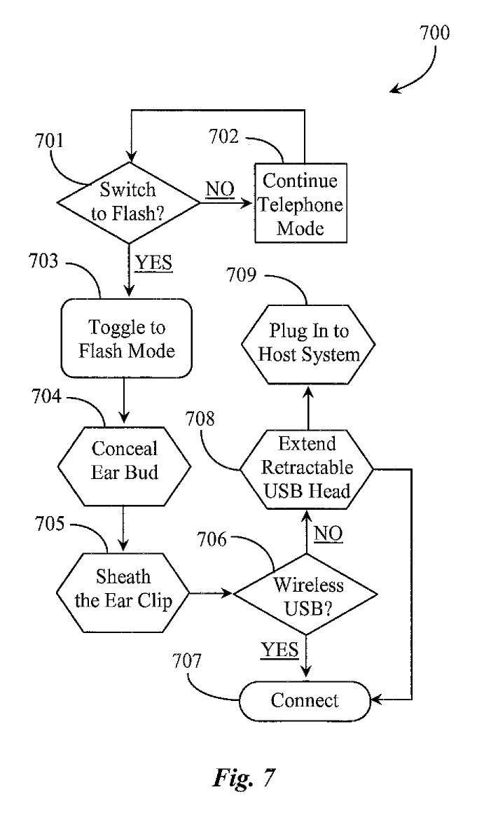

FIG. 7 is a process flow chart illustrating steps 700 for setting the device from telephony mode to flash mode according to an embodiment of the present invention. It is assumed in this example that the device is currently in telephone mode. At step 701 a user may decide to switch modes and use the device as a Flash drive. If at step 701 the user decides to switch to Flash mode then at step 703 the user moves the toggle switch from telephone mode to Flash mode. The user may continue using telephony mode at step 703 until the user decides to switch modes.

Assuming a mode switch to Flash mode, at step 704 the user may take the necessary steps to conceal the ear bud which will not be used in Flash mode. At step 705 the user may sheath the ear clip to conceal the clip within the body of the device.

At step 706 the user may decide whether to use wireless USB or wired USB. At step 706 if the user decides to connect wirelessly, then at step 707 the device automatically connects to the host system and is recognized by the host system as a disk drive. If the user decides to use the device in a wired scenario then at step 708 the user may extend the retractable USB head at the end of the device. At step 709 the user may plug the device into a suitable USB port on a host system and the host will immediately recognize the device as a disk drive and assign a drive letter for identifying and accessing the device through the host system.

Device 100 may be switched to music mode from the telephone mode or from the Flash mode and may be used as a media player. A suitable amount of RAM is provided on the device for storing and loading software programs for manipulating files like a music player for playing music files stored on the device. In one embodiment the device of the present invention may be used to receive and play music sourced on a host system, the unit functioning as an external speaker accessed wirelessly by the host.

It will be apparent to one with skill in the art that the electronic device of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. An electronic device comprising:
a transceiver;
a solid state memory;
a charge port;
at least one speaker, and
a software music player;
characterized in that the device is adapted by toggle interface to function as a telephone hands free earpiece, a wireless flash drive, or a wireless music player.

2. The electronic device of claim 1 wherein the earpiece is enabled for Bluetooth communication.

3. The electronic device of claim 1 wherein the solid state memory is a flash memory recognized as a memory drive by a host system.

4. The electronic device of claim 3 wherein the flash drive is accessible from a host system via wireless USB link.

5. The electronic device of claim 1 further including a retractable USB connector for coupling to a USB port on a host system.

6. The electronic device of claim 1 wherein the speaker is contained in an ear bud integral to the earpiece.

7. The electronic device of claim 6 wherein the ear bud is concealable on the device.

8. The electronic device of claim 1 further including a retractable ear clip that is integral to and concealable on the device.

9. The electronic device of claim 1 further including an audio port for accepting a wired speaker or speaker set.

10. The electronic device of claim 5 wherein the retractable USB connector functions as a charging point.

11. The electronic device of claim 1 further including a visual display screen.

12. The electronic device of claim 11 wherein the display screen is a touch activated screen and is an organic light emitting diode (OLED), or a light emitting diode (LED).

13. The electronic device of claim 12 wherein the contents of the display screen are relevant to the mode selected and include command icons for performing tasks.

14. The electronic device of claim 1 wherein music played on the device is transmitted wirelessly to an external speaker system enabled for wireless reception and analog play.

15. The electronic device of claim 1 further including a miniature stylus for operating the touch screen.

16. The electronic device of claim 1 wherein the toggle interface is activated to switch modes on arrival of a notification event.

17. The electronic device of claim 16 wherein the notification event is a telephone call.
